(19) United States
(12) Patent Application Publication
(10) Pub. No.: US 2008/0091924 A1
(43) Pub. Date: Apr. 17, 2008

(54) Vector processor and system for vector processing

(76) Inventors: Norman P. Jouppi, Palo Alto, CA (US); Jean-Francois Collard, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/581,103

(22) Filed: Oct. 13, 2006

(51) Int. Cl. G06F 9/40

(52) U.S. Cl. 712/216

(57) ABSTRACT

An embodiment of a vector processor includes a vector control and distribution unit and lanes. In operation, the vector control and distribution unit receives vector instructions, decomposes the vector instructions into vector element operations, and forwards the vector element operations for execution. Each lane proceeds to execute vector element operations independently of other lanes. An embodiment of a vector processing system includes a host processor, a main memory, and a vector processor. In operation, the host processor forwards vector instructions and vector data to the vector processor for processing. The vector control and distribution unit decomposes the vector instructions into vector element operations and forwards the vector element operations to the lanes. Each lane proceeds to execute vector element operations that the lane receives on a portion of the vector data independent of execution of instructions executing in other lanes.

### FIELD OF THE INVENTION

The present invention relates to the field of computing. More particularly, the present invention relates to the field of computing where at least some data is processed as a vector.

### BACKGROUND OF THE INVENTION

For more than thirty years, scaling of devices by Moore's Law has provided increasingly fast microprocessors making specialized co-processors less attractive except in high-end computing. The recent saturation of single-threaded performance, however, has generated increased interest in specialized co-processors for computationally demanding workloads.

Some development work has been done using a graphics co-processor for accelerating general purpose computation. Unfortunately, graphics co-processors offer neither double-precision nor IEEE-compliant floating point computations. Indeed, their target market does not require either feature; one wrong pixel does not hurt a gaming experience. Moreover, the use of a graphics accelerator is similar to vector processing but with the disadvantage of requiring long vector lengths to amortize overhead, arcane memory systems, and difficulty in handling scalar and serial computations associated with vector operations that often limit overall performance.

Several vector processors exist that either operate as stand-alone processors or as co-processors. In high-performance implementations, such vector processors distribute element operations from vector instructions to parallel vector lanes. Each vector lane may pipeline multiple vector instructions that execute sequentially. Each set of element operations distributed from a common vector instruction within a lane executes as a single group. In one model, if a later vector instruction is dependent upon an earlier vector instruction, the later vector instruction cannot be executed until the earlier vector instruction completes execution. For example, if a vector load instruction is delayed because a vector data fetch takes an unusually long time, a vector addition operation that operates on the vector data must wait for the vector load instruction to complete prior to execution. This occurs regardless of whether the vector data fetch quickly returns all but a few vector elements of the vector data.

In another model, typically called chaining, execution of subsequent dependent vector instructions may begin if the first element operation of a prior vector instruction has completed and successive element operations are known to be available in successive cycles. An example of this is when a vector add instruction is dependent upon a vector multiplication instruction. In this case, the vector add instruction can begin execution when the first vector multiplication element has been computed, with successive element additions beginning in successive cycles as successive vector multiplication elements are computed. However, chaining does not take advantage of element computations that complete out-of-order, as can be the case when elemental load operations of a vector load instruction may or may not hit in a cache memory. Thus it would be desirable to improve vector processing efficiency when a later vector instruction is dependent upon an earlier vector instruction and the arrival time of successive results is not known.

### SUMMARY OF THE INVENTION

According to an embodiment, a vector processor of the present invention includes a vector control and distribution unit and a plurality of lanes coupled to the vector control and distribution unit. In operation, the vector control and distribution unit receives vector instructions, decomposes the vector instructions into vector element operations, and forwards the vector element operations for execution. Each lane receives a subset of the vector element operations. Each lane proceeds to execute its subset of the vector element operations independently of other lanes.

According to an embodiment, a system for vector processing of the present invention includes a host processor, a main memory, and a vector processor. The vector processor includes a vector control and distribution unit and a plurality of lanes. In operation, the host processor forwards vector instructions and vector data from the main memory to the vector processor for processing. The vector control and distribution unit decomposes the vector instructions into vector element operations and forwards the vector element operations to the lanes. Each lane proceeds to execute the vector element operations that the lane receives independent of execution of the vector element operations executing in other lanes.

### BRIEF DESCRIPTION OF THE DRAWINGS

The present invention is described with respect to particular exemplary embodiments thereof and reference is accordingly made to the drawings in which:

FIG. 1 schematically illustrates an embodiment of a vector processor of the present invention;

FIG. 2 schematically illustrates an embodiment of a system for vector processing of the present invention;

FIG. 3 schematically illustrates another embodiment of a vector processor of the present invention;

FIG. 4 illustrates an exemplary operation of an embodiment of a vector processor of the present invention as a flow chart;

FIG. 5 illustrates an exemplary operation of an embodiment of a vector processor of the present invention as a timing diagram;

FIG. 6 schematically illustrates another embodiment of a vector processor of the present invention;

FIG. 7 illustrates an exemplary operation of an embodiment of a vector processor of the present invention as a flow chart;

FIG. 8 illustrates an exemplary operation of an embodiment of a vector processor of the present invention as a timing diagram;

FIG. 9 schematically illustrates another embodiment of a vector processor of the present invention;

FIG. 10 illustrates an exemplary operation of an embodiment of a vector control and distribution unit and a lane of the present invention as a timing diagram; and;

FIG. 11 illustrates an exemplary operation of an embodiment of a vector control and distribution unit and a lane of the present invention as a timing diagram.

### DETAILED DESCRIPTION OF A PREFERRED EMBODIMENT

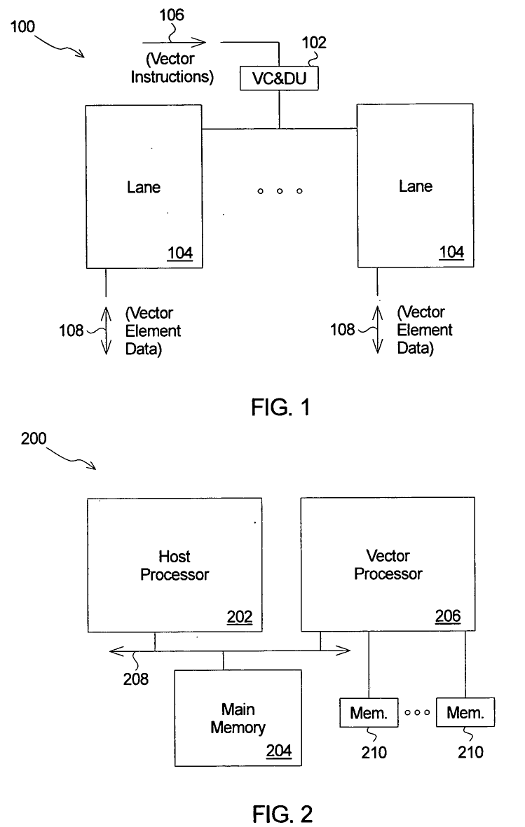

An embodiment of a vector processor of the present invention is illustrated schematically in FIG. 1. The vector processor 100 includes a vector control & distribution unit 102 coupled to a plurality of lanes 104. The vector control & distribution unit 102 may include instruction registers (not shown) and logic circuitry (not shown). Typically, the vector processor includes eight, sixteen, or thirty-two lanes. Each lane 104 may include functional units (not shown) and registers (not shown).

In operation, the vector control & distribution unit 102 receives vector instructions 106 (e.g., from a control unit), decomposes the vector instructions into vector element operations, and forwards the vector element operations to the lanes 104 for processing. The vector element operations in each lane operate on vector element data 108. Each lane 104 receives a portion of the vector element operations. Each lane proceeds to execute its vector element operations independently of execution of vector element operations in other lanes. As used herein, to execute instructions independently of other lanes means to allow lanes to run ahead of other lanes. For example, if a first lane completes execution of a first vector element operation prior to any other lane completing execution of its first vector element operation received in the same time period, the first lane may proceed to begin executing a second vector element operation while the other lanes continue to execute their first vector element operations.

An embodiment of a system for vector processing of the present invention is illustrated schematically in FIG. 2. The system 200 includes a host processor 202, a main memory 204, and a vector processor 206 coupled together by a bus 208 (e.g., a front side bus). The vector processor includes a vector control & distribution unit (e.g., the vector control & distribution unit 102 of FIG. 1) and a plurality of lanes (e.g., the lanes 104 of FIG. 1). The vector processor 206 may couple to a plurality of memory units 210, which may hold vector data that has been striped across the memory units 210.

Typically in operation, the main memory 204 holds vector instructions and vector data. The host processor 202 forwards the vector instructions and the vector data to the vector processor 206. Alternatively, the vector data may reside in the memory units 210 or in caches (not shown). The host processor 202 may communicate with the vector processor 206 using a point-to-point transport protocol (e.g., HyperTransport Protocol). The vector control & distribution unit decomposes the vector instructions into vector element operations and forwards the vector element operations to the lanes. Each lane proceeds to execute the vector element operations that the lane receives on a portion of the vector data independent of execution of the vector element operations executing in other lanes.

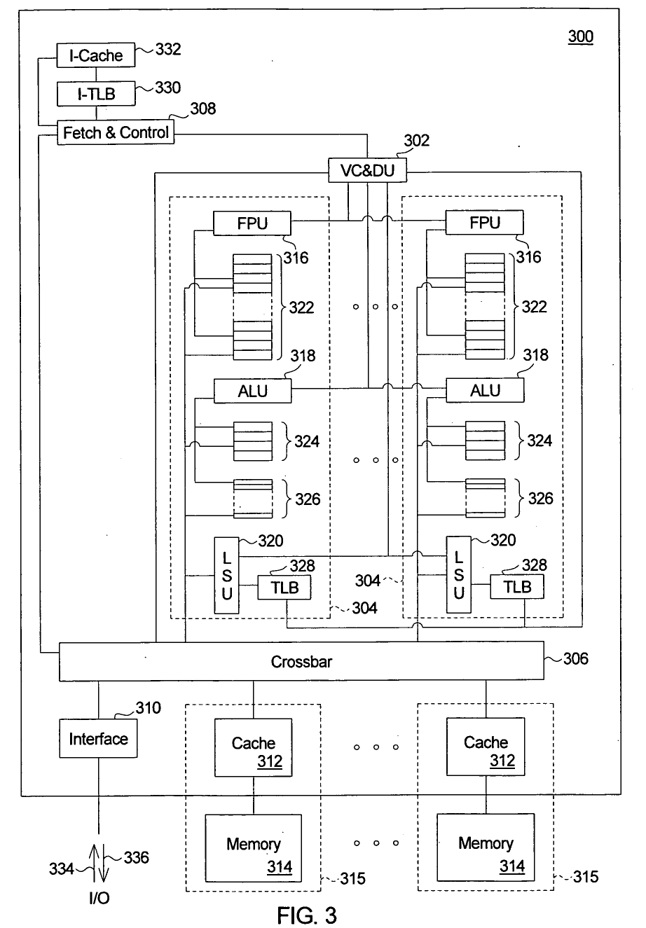

An embodiment of a vector processor of the present invention is illustrated schematically in FIG. 3. The vector processor 300 includes a vector control & distribution unit 302, a plurality of lanes 304, a crossbar switch 306, a fetch & control unit 308, an interface 310 (e.g., a front-side bus interface), and a cache comprising a plurality of cache banks 312. Each lane 304 comprises three functional units, which are a floating point unit 316, an arithmetic logic unit 318, and a load/store unit 320. Each lane 304 further comprises floating point registers 322, bit matrix multiplication registers 324, integer registers 326, and a translation look-aside buffer 328. The fetch & control unit 308 may be augmented by an instruction translation look-aside buffer 330 and an instruction cache 332. Each cache bank 312 couples to a memory unit 314. Each combination of a cache bank 312 and a memory unit 314 forms a memory channel 315. The number of lanes 304 may equal the number of memory channels 315. Or, the number of lanes 304 may exceed or be less than the number of memory channels 315. For example, the number of lanes 304 may be twice the number of memory channels 315.

The crossbar switch 306 provides interconnectivity between components of the vector processor 300. For example, the crossbar switch 306 provides access to any of the memory channels 315 by any of the lanes 304. In an embodiment, each lane 304 has access to a primary memory channel selected from the memory channels 315 in which access by the lane 304 to the primary memory channel is faster than access to others of the memory channels 315.

In operation, the vector processor 300 receives input 334 that includes vector instructions and initial vector data. The initial vector data and other vector data is forwarded to the memory channels 315 (i.e., the cache banks 312, the memory units 314, or a combination of the cache banks 312 and the memory units 314). Vector instructions may also be held in memory channels 315 or may be held in the instruction cache 332. The fetch & control unit 308 forwards the vector instructions to the vector control & distribution unit 302.

The vector control & distribution unit 302 decomposes the vector instructions into vector element operations and forwards the vector element operations to the lanes 304 for processing. The vector control & distribution unit 302 performs a dependency analysis on each vector instruction prior to forwarding its vector element operations to the lanes for processing to determine if the vector instruction is dependent upon an earlier vector instruction. Responsive to the dependency existing, the vector control and distribution unit forwards the vector element operations of the dependent vector instruction to the lanes for execution after forwarding the vector element operations of the vector instruction upon which it depends. Responsive to no dependency, the vector control and distribution unit 302 forwards the vector element operations of the different vector instructions to the lanes for execution independent of a particular order requirement that would be imposed by a dependency. In one example, the vector element operations of the different vector instructions can be forwarded to the lanes 304 at the same time. Particularly for lanes which can execute more than one instruction at a time, this allows for faster execution of the different vector instructions.

The lanes 304 independently execute the vector element operations, which allow some lanes to run-ahead of other lanes. Long latency instructions in a particular lane do not prevent other lanes from executing other instructions. For example, a particular lane may encounter a cache miss while others do not. Over a series of vector instructions, various lanes are likely to experience long latency instructions causing some lanes to at first run ahead of other lanes and then slow down as these lanes encounter long latency instructions. Thus, independent execution of vector element operations in the lanes 304 is expected to provide more efficient processing as long latency instructions occur randomly among the lanes 304.

The load/store units 320 of the lanes 304 load vector data from the memory channels 315. The floating point unit 316 of each lane 304 performs floating point calculations on floating point data that has been loaded into the floating point registers 322 of each lane 304. The arithmetic logic unit 318 performs logic operations and arithmetic operations on data that has been loaded into the integer registers 326 of each lane 304. The arithmetic logic unit 318 also performs bit matrix multiplications in conjunction with other arithmetic logic units 318 of others lanes on data that has been loaded into bit matrix multiplication registers 324. An embodiment of a bit matrix multiplication is discussed in more detail below. Resultant data from the lanes 304 form resultant vector data that may be forwarded to the memory channels 315 or may be forwarded to the interface 310 to form output 336.

The cache 312 perform several functions including increasing bandwidth for memory references that fit in the cache 312, reducing the power of accessing the memory units 314, which are located off-chip, and acting as buffers for communications between lanes. Use of the cache 312 also reduces latency for memory operations.

An embodiment of a bit matrix multiplication of matrices A and B performed on the vector processor 300 performs a logical AND operation of each bit in a row of matrix A and the corresponding bit in a row of matrix B, then performs a logical XOR to find the resultant bit value. This is repeated using one row of A and each row of B to create one output row. The process is then repeated for the other rows of A to create other output rows. Each lane performs a local bitwise AND on its portions of matrices A and B. These intermediate results are combined in a tree-like fashion by all lanes communicating by way of the crossbar switch 306. Synchronization point instructions may be inserted in the vector element operations provided to each lane to ensure proper coordination of the combination of intermediate results.

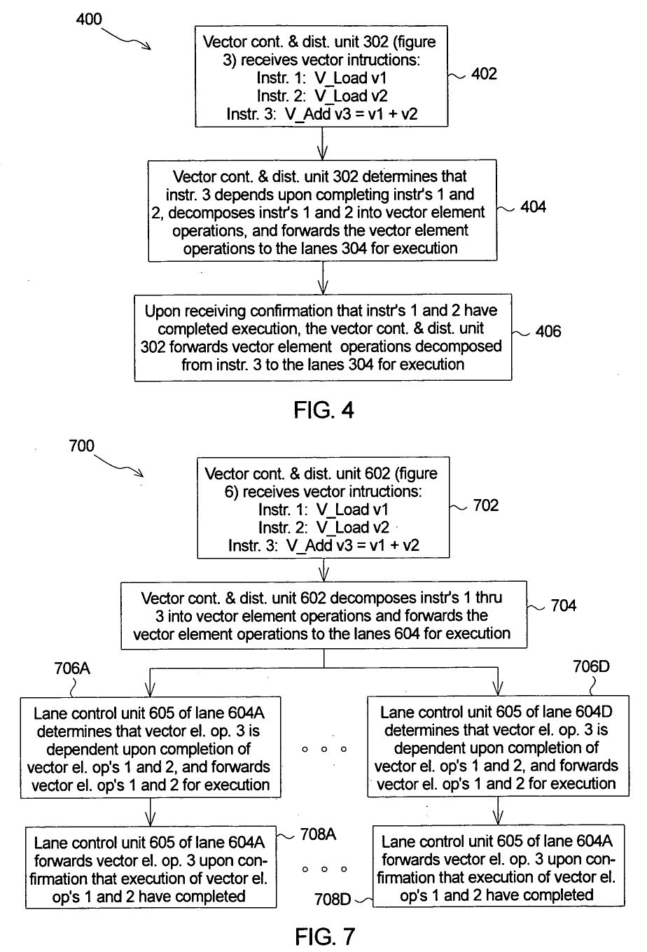

An exemplary operation of the vector processor 300 is illustrated as a flow chart in FIG. 4. The exemplary operation 400 of the vector processor 300 (FIG. 3) begins with a first step 402 of the vector control & distribution unit 302 receiving three vector instructions. The three vector instructions are loading of vector v1, loading of vector v2, and vector addition of vectors v1 and v2 to produce resultant vector v3. Each vector has four elements. Vector v1's elements are referred to as v1A, v1B, v1C and v1D; a similar notation is used for vectors v2 and v3. This means that, if there are least four lanes 304 in the vector processor 300, the vector instructions will preferably be executed by four lanes. In a second step 304, the vector control & distribution unit 302 finds that loading of vector v1 and v2 are not dependent upon an earlier instruction or upon each other and, consequently, forwards vector element operations decomposed from these vector instructions to the lanes for processing. In a third step 406, the vector control & distribution unit 302 releases vector element operations decomposed from the third vector instruction after sending the vector element operations decomposed from the first two vector instructions upon which it depends.

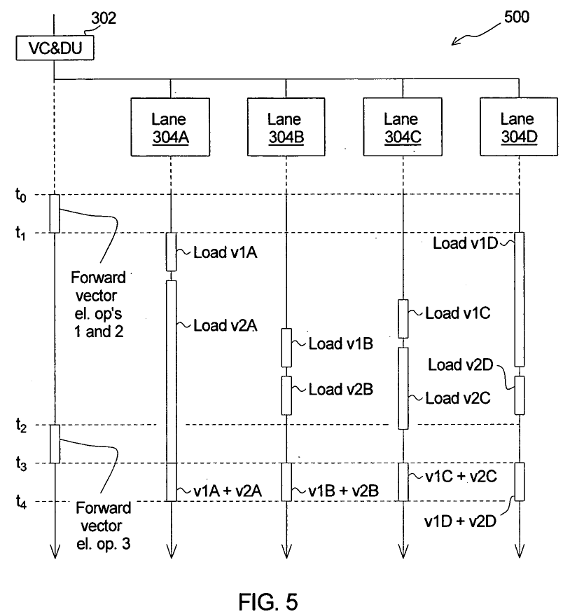

A timing diagram illustrating the exemplary operation 400 is shown in FIG. 5. The timing diagram 500 includes time lines for the vector control & distribution unit 302 and first through fourth lanes, 304A . . . 304D. The vector control & distribution unit 302 forwards first and second sets of vector element operations, load v1A . . . v1D and load v2A . . . v2D, to the first through fourth lanes, 304A . . . 304D, respectively, between time t₀ to t₁. The first and second sets of vector element operations, load v1A . . . v1D and load v2A . . . v2D, have been decomposed from first and second vector instructions, load vectors v1 and v2, respectively. Each lane proceeds to execute these vector element operations independently of other lanes between times t₁ and t₃ and confirms completion or impending completion to the vector control & distribution unit 302 by time t₂.

Impending completion can be computed for fixed-latency functional units (such as arithmetic units) once an element operation has been initiated by adding the functional unit latency to the cycle the operation was initiated, producing the cycle the result will be available. In practice this is often implemented by simply pipelining a completion notification by N fewer pipestages than the computed result of the fixed-latency functional unit, starting from the initiation of the computation. This results in a completion notification that is produced N cycles before the result. Impending completion in advance of results by more than one cycle is often difficult or impossible for variable latency functional units such as cache memories that may hit or miss. For these units, once cycle advance notification can still be provided as follows. For example, in the case of a set-associative cache, the fact that a hit has occurred and the way of the set which hits is often known a small amount before the data is produced, since the way that hits must be used to select the result from among the different ways of the cache. Note that once a cache miss has occurred, if data is being retrieved from DRAM memories instead of another level of cache, because the timing characteristics of the DRAMs are known, once the DRAM access has been inititated the impending availability of the results can be known in advance of the arrival of the result data.

Between times t₂ and t₃, the vector control & distribution unit 302 releases a third set of vector element operations, add v1A and v2A . . . add v1D and v2D, to the first through fourth lanes, 304A . . . 304D, respectively. The first through fourth lanes, 304A . . . 304D, execute the third set of vector element operations by time t₄.

As depicted in the timing diagram 500, the first lane 304A runs ahead of the other lanes when it completes execution of load v1A and begins executing load v2A. Further, the third lane 304C runs ahead of the second and fourth lanes, 304B and 304D, when it completes execution of load v1C and begins executing load v2C. The ability of lanes to run ahead of other lanes accommodates situations where some vector element data of a particular vector is found in cache and remaining vector element data of the particular vector must be retrieved from memory. Because retrieving data from memory has a longer latency than retrieving data from cache, the ability to run ahead allows the lanes that receive data from cache to begin executing next vector element operations ahead of lanes that retrieve data from memory. Over time, it is anticipated that cache misses will be dispersed among lanes leading to some lanes to run ahead initially and other lanes to catch up with these lanes later.

As depicted in the timing diagram 500, the vector control & distribution unit 302 releases the third vector element operations as a pipeline operation in anticipation of the first lane 304A completing its second vector element operation (i.e., load v2A). Employing the pipeline operation allows each of the first through fourth lanes, 304A . . . 304D, to immediately execute its third vector element operation upon completion of the first and second vector element operations by all of the lanes.

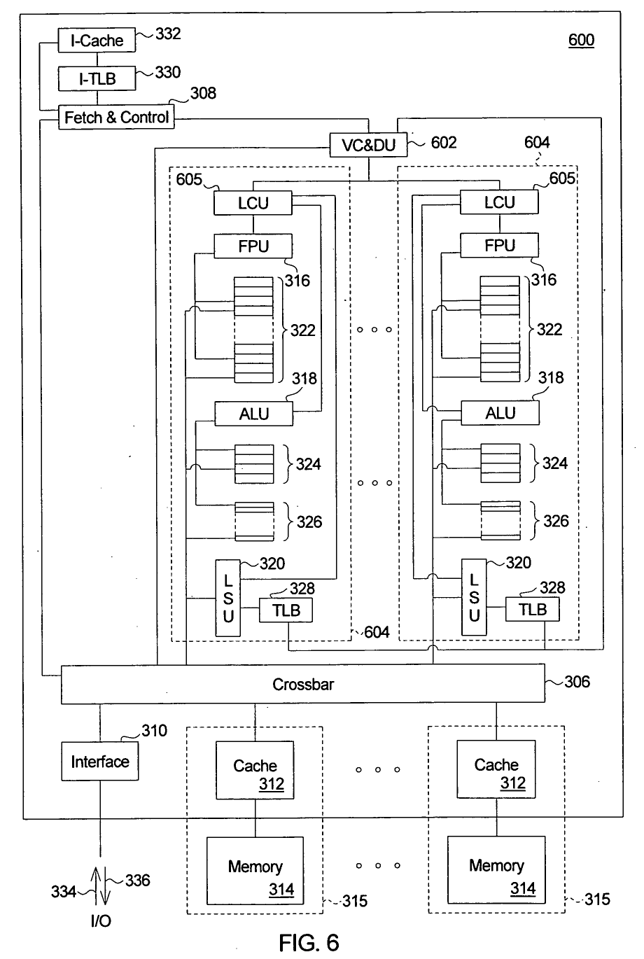

Another embodiment of a vector processor of the present invention is illustrated schematically in FIG. 6. The vector processor 600 replaces the vector control & distribution unit 302 and the lanes 304 of the vector processor 300 (FIG. 3) with an alternative vector control & distribution unit 602 and alternative lanes 604. Each of the lanes 604 includes a lane control unit 605 that couples the vector control & distribution unit 602 to other components of the lane 604. The other components of each lane 604 are as described relative to the vector processor 300 (FIG. 3). In the vector processor 600, the lane control unit 605 of each lane 604 performs an intra-lane dependency analysis. The intra-lane dependency analysis determines whether a particular vector element operation received by the lane 604 must wait for an earlier vector element operation to execute within the lane prior to the particular vector element operation being processed by the lane. If a particular lane receives multiple vector element operations decomposed from a single vector instruction, the particular lane need not perform the intra-lane dependency analysis because such instructions decomposed from a single vector instruction are not dependent upon each other.

An exemplary operation of the vector processor 600 is illustrated as a flow chart in FIG. 7. The exemplary operation 700 of the vector processor 600 (FIG. 6) begins with a first step 702 of the vector control & distribution unit 602 receiving three vector instructions. In a second step 704, the vector control & distribution unit 602 determines that there are no inter-lane dependencies between these instructions and forwards vector element operations decomposed from the three vector instructions to the lanes 604 for processing. In third steps 706A . . . 706D, each lane control unit 605 finds that loading of vector element operations that have been decomposed from the first and second vector instructions are not dependent upon an earlier vector element operation in the same lane and, consequently, forwards these instructions for processing. In fourth steps 708A . . . 708D, each lane control unit 605 forwards a vector element operation decomposed from the third vector instruction upon confirmation that the lane has completed executing first and second vector element operations that were decomposed from the first and second vector instructions.

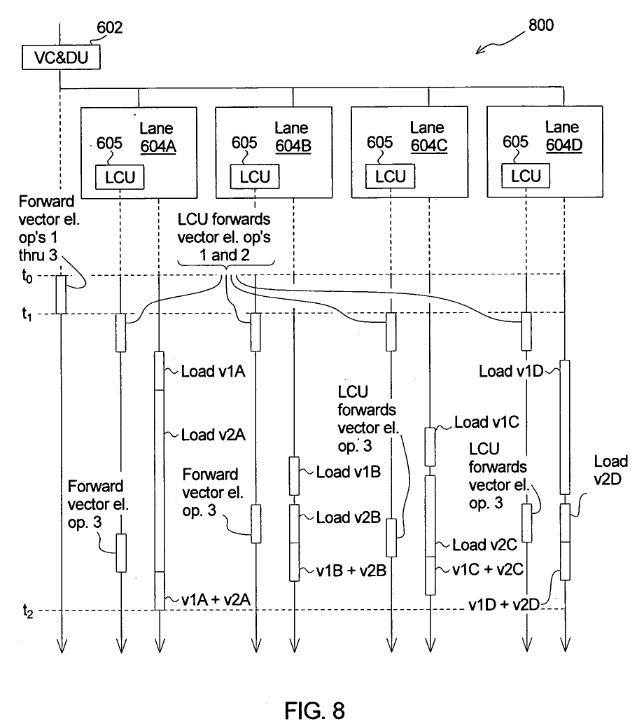

A timing diagram illustrating the exemplary operation 700 is shown in FIG. 8. The timing diagram 800 includes a time line for the vector control & distribution unit 602 and first through fourth lanes, 604A . . . 604D. The vector control & distribution unit 602 forwards first through third sets of vector element operations, load v1A . . . v1D, load v2A . . . v2D, and add v1A and v2A . . . add v1D and v2D to the lane control units 605 of the first through fourth lanes, 604A . . . 604D, respectively, between time t₀ to t₁. Beginning at time t₁, each lane control unit 605 releases first and second sets of vector element operations that have been decomposed from the first and second vector instructions, respectively. Each lane proceeds to execute its vector element operations independently of others lanes between times t₁ and t₂. Each lane confirms impending completion of its vector element operations to the lane control unit 605 at various times. Upon receiving the impending completion confirmation, the lane control unit 605 of each lane releases a third vector element operation that has been decomposed from the third vector instruction and the lane proceeds to execute the third vector element operation. As depicted in the timing diagram 700, each lane control unit 605 releases the third vector element operation as a pipeline operation so that the lane is able to immediately execute the third vector element operation upon completion of the first and second vector element operations.

As depicted in the timing diagram 800, the first lane 604A runs ahead of the second through fourth lanes, 604B . . . 604D, when it completes execution of load v1A and begins executing load v2A. The third lane 604C runs ahead of the second and fourth lanes, 604B and 604D, when it completes execution of load v1C and begins executing load v2C. Further, the second and fourth lanes, 604B and 604D, run ahead of the first and third lanes, 604A and 604D, when the second and fourth lanes, 604B and 604D, complete execution of load v2B and load v2D and begin execution of second and fourth lane additions, respectively.

In the vector processor 600, the vector control & distribution unit 602 contributes to resolving a cross-lane dependency requirement. A cross-lane dependency requirement arises where an instruction within a particular lane cannot be executed until an instruction within another lane completes execution. In an embodiment, the vector control & distribution unit 602 resolves the cross-lane dependency requirement by awaiting confirmation of fulfillment or impending fulfillment of the cross-lane dependency requirement prior to releasing vector element operations that depend upon the cross-lane dependency requirement. In another embodiment, the vector control & distribution unit 602 forwards inter-lane dependency instructions to the lane control units 605 that instruct the lanes 604 to await fulfillment or impending fulfillment of an inter-lane dependency requirement prior to the lanes 604 executing vector element operations that depend upon the inter-lane dependency requirement.

An example depicts operation of the vector processor 600 when a cross lane dependency exists and where the vector control & distribution unit 602 resolves the dependency. The vector control & distribution unit 602 of the vector processor 600 (FIG. 6) receives first and second vector instructions. The first vector instruction is a vector store of a vector having four vector elements. The second vector instruction is a vector load of four vector elements. Because the addresses of load and store instructions are not known until the instructions are executed, and the address range of the load and store may overlap, the distribution of the second instruction must be delayed until all element operations from the first instruction can be guaranteed to execute before the second instruction.

In an embodiment of the vector processor 600, the lane control units 605 may independently adjust pipelining of their vector element operations. For example, with reference to the timing diagram 800, the lane control unit 605 of the first lane 604A may reverse the order of load v1A and load v2A.

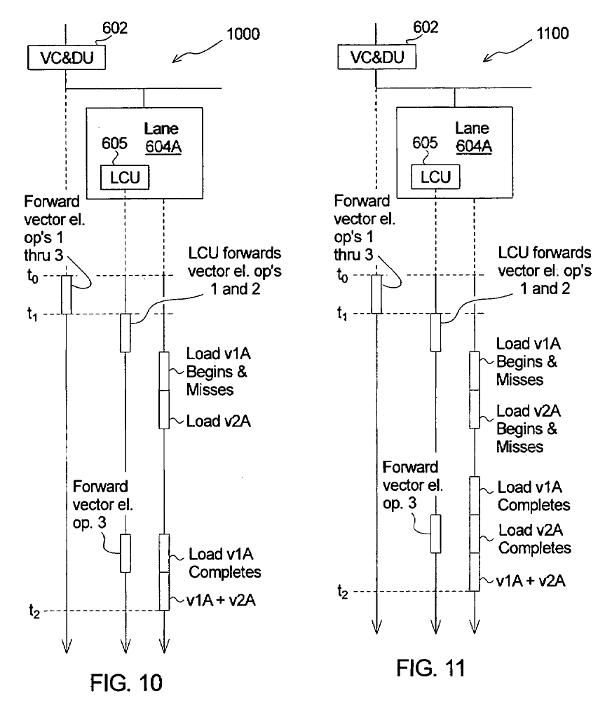

Another example of independent adjustment of pipelining within a lane is provided as timing diagram in FIG. 10. In exemplary operation 1000, the lane control unit 605 forwards vector element operations 1 and 2 to the first lane 604A with direction to begin processing a next operation if a cache miss is encountered. Load v1A encounters a cache miss and, consequently, load v2A executes. Later, load v1A completes execution.

Another example of independent adjustment of pipelining within a lane is provided as timing diagram in FIG. 11. In exemplary operation 1100, the lane control unit 605 forwards vector element operations 1 and 2 to the first lane 604A with direction to begin processing a next operation if a cache miss is encountered. Load v1A encounters a cache miss. Load v2A begins execution and also encounters a cache miss. Later, load v1A completes execution and then load v2A completes execution. In one example, each lane can issue a plurality of independent operations in a same time period (for example a cycle) so that operations can execute at the same time within the same lane.

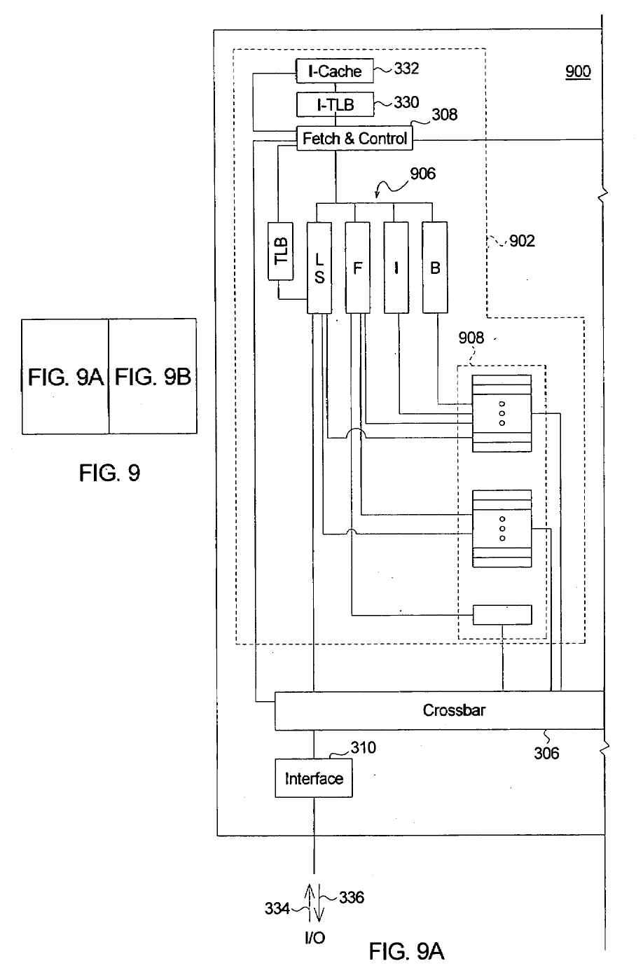

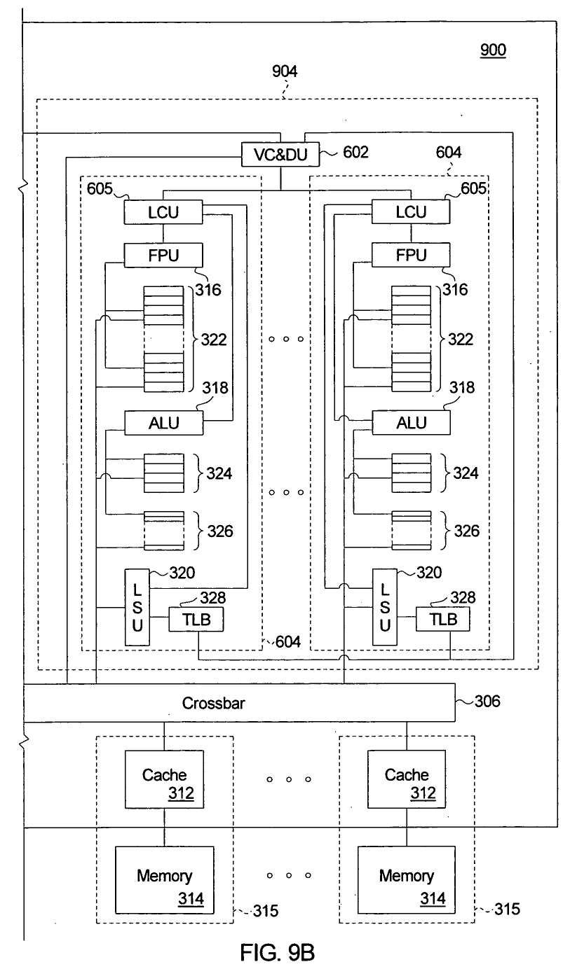

Another embodiment of a vector processor of the present invention is illustrated schematically in FIG. 9. The vector processor 900 includes a scalar unit 902 and a vector unit 904. The scalar unit 902 includes the fetch & control unit 308, the instruction translation look-aside buffer 330, the instruction cache 332, functional units 906, registers 908, and a translation look-aside buffer 910. The vector unit 904 includes the vector control & distribution unit 602 and the lanes 604. The scalar unit 902 executes scalar load and stores, scalar floating point calculations, scalar integer calculations, and branches. The scalar unit 902 by way of the fetch & control unit 308 also provides vector instructions to the vector unit 904. The vector unit 904 operates according to the description of the vector control & distribution unit 602 and the lanes 604 discussed above relative to the vector processor 600 (FIG. 6).

The foregoing detailed description of the present invention is provided for the purposes of illustration and is not intended to be exhaustive or to limit the invention to the embodiments disclosed. Accordingly, the scope of the present invention is defined by the appended claims.

What is claimed is:

1. A vector processor comprising:
a vector control and distribution unit configured for receiving a plurality of vector instructions and decomposing the vector instructions into vector element operations; and
a plurality of lanes coupled to the vector control and distribution unit for receiving vector element operations wherein each lane receives a subset of vector element operations together and executes its subset independently of the other lanes.

2. The vector processor of claim 1 wherein the vector control and distribution unit determines whether there is a dependency between different vector instructions, and
responsive to the dependency existing, the vector control and distribution unit forwarding the vector element operations of the dependent vector instruction to the lanes for execution after forwarding the vector element operations of the vector instruction upon which it depends, and
responsive to no dependency, the vector control and distribution unit forwarding, independently of an order, the vector element operations of the different vector instructions to the lanes for execution.

3. The vector processor of claim 2 wherein the subset of vector element operations received together for a respective lane include vector element operations from different vector instructions.

4. The vector processor of claim 2 wherein each lane includes a lane control unit communicatively coupled to the vector control and distribution unit, and responsive to no dependency, the respective lane control unit executing, independently of an order, the vector element operations of the different vector instructions received in the subset for its lane.

5. The vector processor of claim 2 wherein two independent vector element operations are executing at the same time within the same lane.

6. The vector processor of claim 4 wherein responsive to a dependency, the lane control unit orders the execution of the vector element operations for the dependent vector element operation to begin execution after the vector element operation upon which it depends.

7. The vector processor of claim 1 wherein a first lane of the plurality of lanes runs ahead in execution of vector element operations of a second lane in the plurality of lanes.

8. The vector processor of claim 7 wherein the first lane and the second lane receive their respective first vector element operations in the same time period and the first lane completes execution of its first vector element operation prior to the second lane completing execution of its first vector element operation, and the first lane proceeding to execute a second vector element operation while the second lane continues to execute its first vector element operation

9. The vector processor of claim 1 further comprising a crossbar switch, a plurality of cache banks, and a plurality of memory units, the crossbar switch coupling each lane to the plurality of memory units, each cache coupling a memory unit of the plurality of memory units to the crossbar switch.

10. The vector processor of claim 9 wherein the plurality of memory units comprise memory modules separate from a vector processor module that includes the vector control and distribution unit and the plurality of lanes.

11. The vector processor of claim 10 wherein each lane has a primary memory channel for providing faster access for the respective lane to its respective memory unit and its associated cache bank.

12. The vector processor of claim 1 wherein each lane comprises functional units and registers, the functional units of each lane include a floating point unit, an arithmetic logic unit, and a load/store unit and wherein in operation:
the arithmetic logic unit of each lane performs integer operations, bit matrix multiplications, and address computations; and
the bit matrix multiplications performed by each lane are performed in conjunction with the bit matrix multiplications performed by other arithmetic logic units within the other lanes and each bit matrix multiplication includes at least one synchronization point instruction alerting each lane to await synchronization with the other lanes.

13. The vector processor of claim 1 wherein the vector control and distribution unit and the plurality of lanes comprise a vector unit and further comprising a scalar unit that includes a control unit that forwards the vector instructions to the vector control and distribution unit.

14. A system for vector processing comprising:
a host processor;
a main memory coupled to the host processor that holds vector instructions and vector data; and
a vector processor coupled to the host processor, the vector processor comprising a vector control and distribution unit and a plurality of lanes configured such that in operation the host processor forwards the vector instructions and the vector data to the vector processor for processing, the vector control and distribution unit
decomposes the vector instructions into vector element operations,
determines whether there is a dependency between a first vector element operation of a first vector instruction and a second vector element operation of a second vector instruction, and
responsive to the dependency existing, the vector control and distribution unit forwarding the vector element operations of the first vector instruction to the lanes for execution before forwarding the vector element operations of the second vector instruction to the lanes for execution, and
responsive to no dependency, the vector control and distribution unit forwarding, independently of an order, the vector element operations of the first and second vector instructions to the lanes for execution

15. The system of claim 14 wherein each lane further comprises a lane control unit communicatively coupled to the vector control and distribution unit, the lane control unit determining whether there is a dependency between vector element operations from different vector instructions received in its respective lane, and responsive to no dependency, executing, independently of an order, the vector element operations.

16. The system of claim 15 wherein responsive to a dependency, the lane control unit orders the execution of the vector element operations for the dependent vector element operation to begin execution after the vector element operation upon which it depends.

17. The system of claim 14 wherein the vector processor further comprises a crossbar switch and a plurality of cache banks, the crossbar switch coupling the plurality of lanes, the host processor, and the main memory to the plurality of cache banks.

18. The system of claim 14 further comprising a plurality of memory modules, each cache bank coupling to a memory module selected from the plurality of memory modules such that in operation the vector processor receives the vector data and stores the vector data across the cache banks, across the memory modules, or across a combination of both the cache banks and the memory modules for convenient access by the lanes.

19. The system of claim 14 wherein each lane has a primary memory channel for providing faster access for the respective lane to its respective memory unit and its associated cache bank.
